(19) United States
(12) Patent Application Publication
(10) Pub. No.: US 2017/0160579 A1
(43) Pub. Date: Jun. 8, 2017

(54) MANUFACTURE METHOD OF POLARIZATION AND ALIGNMENT FUNCTION INTEGRATION FILM AND LIQUID CRYSTAL DISPLAY PANEL

(71) Applicant: Shenzhen china Star Optoelectronics Technology Co. Ltd., Shenzhen City (CN)

(72) Inventors: Xiaoping Cheng, Shenzhen City (CN); Zhenxia Chen, Shenzhen City (CN); Hsiaohsien Chen, Shenzhen City (CN)

(21) Appl. No.: 14/888,448

(22) PCT Filed: Oct. 12, 2015
(86) PCT No.: PCT/CN2015/091713

§ 371 Date: Nov. 2, 2015

(30) Foreign Application Priority Data
Sep. 8, 2015 (CN) 201510568250.X

(51) Int. Cl. G02F 1/1347; G02F 1/1335; G02F 1/1337

(52) U.S. Cl. CPC G02F 1/13475; G02F 1/1337; G02F 1/133528; G02F 2202/043

(57) ABSTRACT

The present invention provides a manufacture method of a polarization and alignment function integration film and a liquid crystal display panel comprising the polarization and alignment function integration film. The manufactured polarization and alignment function integration film manufactured by the manufactured method has polarization property and alignment function. As the polarization and alignment function integration film is applied in the liquid crystal display panel, it can replace the polarizer and the alignment film in the liquid crystal display panel according to prior art for decreasing the type and the amount of the optical films and saving one polarizer alignment process. Significantly, the production process is simplified and the production cost is saved to gain the benefits of cost reduction. Besides, the polarization and alignment function integration film is particularly applicable for the liquid crystal display panel structure which needs to locate the polarizer inside.

### FIELD OF THE INVENTION

The present invention relates to a display technology field, and more particularly to a manufacture method of a polarization and alignment function integration film and a liquid crystal display panel.

### BACKGROUND OF THE INVENTION

With the development of the technology and the progress of the society, the people rely on the information exchange and delivery more and more. The display device is the main carrier and the material basis of the information exchange and delivery, which already become the hot point and high ground that a lot of scientists in the information photoelectricity research fight and seize. The polarization component is a very important element in the LCD (Liquid Crystal Display). Without the polarization component, the LCD won't generate images. Meanwhile, it significantly determines the key property index of the LCD, such as transmission ratio, brightness, and etc.

Many of the polarizer unit (element) manufactured by the traditional method uses the raw iodine to be the dichroic material, and formed by laminating a plurality of films. The thickness cannot be smaller than 200 μm. However, the sublimability of the iodine is high, and therefore, the heat resistance and the light resistance are bad; and the delustering color of the iodine is deep blue. Therefore, it is not an ideal colorless polarizer for the entire visible light range.

The liquid crystal display is developed to possess integration and flexibility, which require the components to be thin films. That includes the polarizer. For compensating the insufficiency of the iodine polarizer, the dichroic dye is commonly used to replace the iodine for manufacturing the polarizer. The principle of manufacturing the polarizer with the dichroic dye is to align the dichroic dye molecules in a certain way by stretching orientation, rubbing or molecular self-assembly to form a dye film having polarization property. When the lights having various polarization directions pass through, some is blocked, and some can pass. The polarization directions of the passing through lights are the same, i.e. becoming the linearly polarized light, and the higher degree of polarization can be obtained. The dye film polarizer has properties of high thermostability, high humidity tolerance, lightfastness, and particularly suitable to be used in the severe environments, such as, the LCD display in vehicle, outdoor, in projector.

Besides, the alignment film is also a very important component in the liquid crystal display, which acts to control the alignment directions of the liquid crystal molecules. The alignment film requires the alignment treatment for effectively control the alignments of the liquid crystal molecules.

FIG. 1 is a sectional structure diagram of a liquid crystal display panel according to prior art. The liquid crystal display panel comprises an upper substrate 100 and a lower substrate 200 which are oppositely located and a liquid crystal layer 300 located between the upper substrate 100 and the lower substrate 200, an upper polarizer 400, a lower polarizer 500 respectively located above the upper substrate 100 and under the lower substrate 200.

the upper substrate 100 comprises a first substrate 110, a black matrix 120 located on the first substrate 110, a color resist layer 130 located on the first substrate 110 and the black matrix 120 and an alignment film 140 located on the color resist layer 130;

the lower substrate 200 comprises a second substrate 210, a thin film transistor layer 220 located on the second substrate 210, an alignment film 140 located on the thin film transistor layer 220.

The liquid crystal display panel shown in FIG. 1 requires to use the upper, lower, two alignment films, and the upper, lower two polarizers. The structure is complicated, and the manufacture cost is high. The color resist layer 130 generally comprises quantum dot material. Because the color resist layer 130 is in the upper substrate 100 which is close to the illuminating interface, the ambient light can easily enters to excite the quantum dots in the color resist layer 130 to generated unnecessary light and influence the image quality of the device.

FIG. 2 is a sectional structure diagram of another liquid crystal display panel according to prior art. The liquid crystal display panel comprises an upper substrate 100 and a lower substrate 200 which are oppositely located and a liquid crystal layer 300 located between the upper substrate 100 and the lower substrate 200, an upper polarizer 400, a lower polarizer 500 respectively located above the upper substrate 100 and under the lower substrate 200;

the upper substrate 100 comprises a first substrate 110, a black matrix 120 located on the first substrate 110 and an alignment film 140 located on the black matrix 120;

the lower substrate 200 comprises a second substrate 210, a thin film transistor layer 220 located on the second substrate 210, a color resist layer 230 located on the thin film transistor layer 220, a pixel electrode layer 240 located on the color resist layer 230, an alignment film 140 located on the pixel electrode layer 240.

The liquid crystal display panel shown in FIG. 2 requires to use the upper, lower, two alignment films, and the upper, lower two polarizers. The structure is complicated, and the manufacture cost is high. The color resist layer 130 generally comprises quantum dot material. After the backlight in the liquid crystal display panel passes through the lower polarizer 500, the generated light is the linearly polarized light of particular direction. After the linearly polarized light excites the quantum dots in the color resist layer 130, the light of certain spectrum is formed by exciting the quantum dots. Such light is divergent and directly penetrates through the liquid crystals. The polarization state of the polarized light of original particular direction will change (the directions of depolarization and polarization change), and results in the happening of the light leakage phenomenon. Therefore, for the liquid crystal display panel of which the color resist layer comprises quantum dot material, the polarizer is generally required to be located inside.

### SUMMARY OF THE INVENTION

An objective of the present invention is to provide a manufacture method of a polarization and alignment function integration film. The manufactured polarization and alignment function integration film has polarization property and alignment function. As the polarization and alignment function integration film is applied in a liquid crystal display panel, it can replace the polarizer and the alignment film in the liquid crystal display panel according to prior art for decreasing the type and the amount of the optical films and saving one polarizer alignment process. Significantly, the production process is simplified and the production cost is saved to gain the benefits of cost reduction. Besides, the polarization and alignment function integration film is particularly applicable for the liquid crystal display panel structure which needs to locate the polarizer inside.

An objective of the present invention is to provide a liquid crystal display panel, which uses the polarization and alignment function integration film having polarization property and alignment function to replace the polarizer and the alignment film in the liquid crystal display panel according to prior art for decreasing the type and the amount of the optical films and saving one polarizer alignment process. Significantly, the production process is simplified and the production cost is saved to gain the benefits of cost reduction.

For realizing the aforesaid objective, the present invention provides a manufacture method of a polarization and alignment function integration film, comprising steps of:

step 1, forming a mixed dye thin film containing dichroic dye and alignment material on a substrate;

step 2, implementing polarization treatment to the mixed dye thin film, and a process of the polarization treatment is to generate orientation under functions of stretching orientation, rubbing, molecular self-assembly or electrical field force.

The alignment material is normal alignment material or light alignment material.

As the alignment material is normal alignment material, after the polarization treatment in the step 2, the dichroic dye in the mixed dye thin film is aligned according to a way, and the normal alignment material in the mixed dye thin film is aligned according to another way to form the polarization and alignment function integration film.

As the alignment material is light alignment material, the method further comprises step 3, implementing light alignment treatment to the mixed dye thin film to form the polarization and alignment function integration film.

The dichroic dye is azobenzene or anthraquinone.

In the step 1, a solution film forming method or an evaporation method is employed to form the mixed dye thin film;

as in the step 1, the solution film forming method is employed to form the mixed dye thin film, the step 1 comprises:

step 11, respectively weighting the dichroic dye, the alignment material and solvent, and dissolving polarization dye and the alignment material in the solvent to manufacture a mixed material;

step 12, providing a substrate, coating the mixed material on the substrate with the solution film forming method, and forming a mixed dye thin film after removing the solvent;

as in the step 1, the evaporation method is employed to form the mixed dye thin film, the step 1 specifically comprises:

step 11′, respectively weighting the dichroic dye and the alignment material, and uniformly mixing the two to obtain a mixed material;

step 12′, providing a substrate, and plating the mixed material on the substrate with the evaporation method to form a mixed dye thin film.

The present invention further provides a manufacture method of a polarization and alignment function integration film, comprising steps of:

step 1, employing chemical reaction method to introduce a group having alignment function in dichroic dye molecules to obtain a dye compound;

step 2, forming a dye thin film containing the dye compound on a substrate;

step 3, implementing polarization treatment to the mixed dye thin film to form the polarization and alignment function integration film; a process of the polarization treatment is to generate orientation under functions of stretching orientation, rubbing, molecular self-assembly or electrical field force.

In the step 2, a solution film forming method or an evaporation method is employed to form the dye thin film;

as in the step 2, the solution film forming method is employed to form the dye thin film, the step 2 specifically comprises:

step 21, respectively weighting the dye compound and solvent, and dissolving dye compound in the solvent to manufacture a mixed material;

step 22, providing a substrate, coating the mixed material on the substrate with the solution film forming method, and forming a dye thin film after removing the solvent;

as in the step 2, the evaporation method is employed to form the dye thin film, the step 2 specifically is: weighting the dye compound of a proper volume, and providing a substrate, and plating the dye compound on the substrate with the evaporation method to form a dye thin film.

The dichroic dye is azobenzene or anthraquinone.

The present invention further provides a liquid crystal display panel, comprising an upper substrate and a lower substrate which are oppositely located and a liquid crystal layer located between the upper substrate and the lower substrate, wherein polarization and alignment function integration films are located on surfaces at sides of the upper substrate and the lower substrate facing the liquid crystal layer;

wherein the polarization and alignment function integration films are polarization and alignment function integration films obtained by utilizing any one of the aforesaid manufacture methods.

The benefits of the present invention are: the present invention provides a manufacture method of a polarization and alignment function integration film and a liquid crystal display panel comprising the polarization and alignment function integration film. The manufactured polarization and alignment function integration film manufactured by the manufactured method has polarization property and alignment function. As the polarization and alignment function integration film is applied in the liquid crystal display panel, it can replace the polarizer and the alignment film in the liquid crystal display panel according to prior art for decreasing the type and the amount of the optical films and saving one polarizer alignment process. Significantly, the production process is simplified and the production cost is saved to gain the benefits of cost reduction. Besides, the polarization and alignment function integration film is particularly applicable for the liquid crystal display panel structure which needs to locate the polarizer inside. The present invention provides a liquid crystal display panel, which use the polarization and alignment function integration film having polarization property and alignment function to replace the polarizer and the alignment film in the liquid crystal display panel according to prior art for decreasing the type and the amount of the optical films and saving one polarizer alignment process. Significantly, the production process is simplified and the production cost is saved to gain the benefits of cost reduction.

### BRIEF DESCRIPTION OF THE DRAWINGS

The technical solution and the beneficial effects of the present invention are best understood from the following detailed description with reference to the accompanying figures and embodiments.

In drawings,

FIG. 1 is a sectional structure diagram of a liquid crystal display panel according to prior art;

FIG. 2 is a sectional structure diagram of another liquid crystal display panel according to prior art;

FIG. 3 is a flowchart of a manufacture method of a polarization and alignment function integration film according to the present invention;

FIG. 4 is a flowchart of the first embodiment of the manufacture method of the polarization and alignment function integration film shown in FIG. 3;

FIG. 5a to FIG. 5c are diagrams of the manufacture method of the polarization and alignment function integration film in FIG. 4;

FIG. 6 is a flowchart of the second embodiment of the manufacture method of the polarization and alignment function integration film shown in FIG. 3;

FIG. 7a to FIG. 7d are diagrams of the manufacture method of a dye film having the polarization and alignment properties in FIG. 6;

FIG. 8 is a flowchart of another manufacture method of a polarization and alignment function integration film according to the present invention;

FIG. 9a to FIG. 9c are diagrams of the manufacture method of the polarization and alignment function integration film in FIG. 8;

FIG. 10 is a sectional structure diagram of the first embodiment in a liquid crystal display panel according to the present invention;

FIG. 11 is a sectional structure diagram of the second embodiment in a liquid crystal display panel according to the present invention.

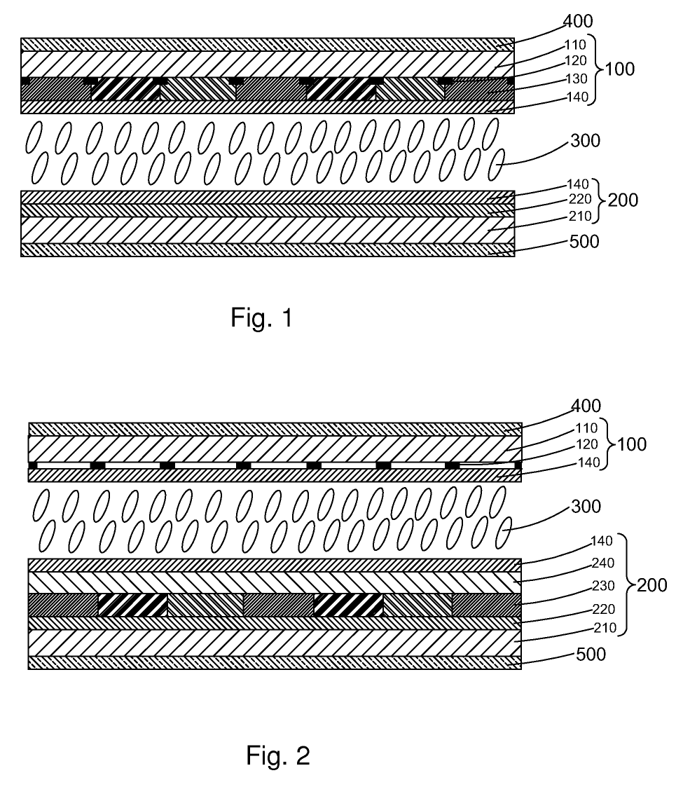

### DETAILED DESCRIPTION OF PREFERRED EMBODIMENTS

For better explaining the technical solution and the effect of the present invention, the present invention will be further described in detail with the accompanying drawings and the specific embodiments.

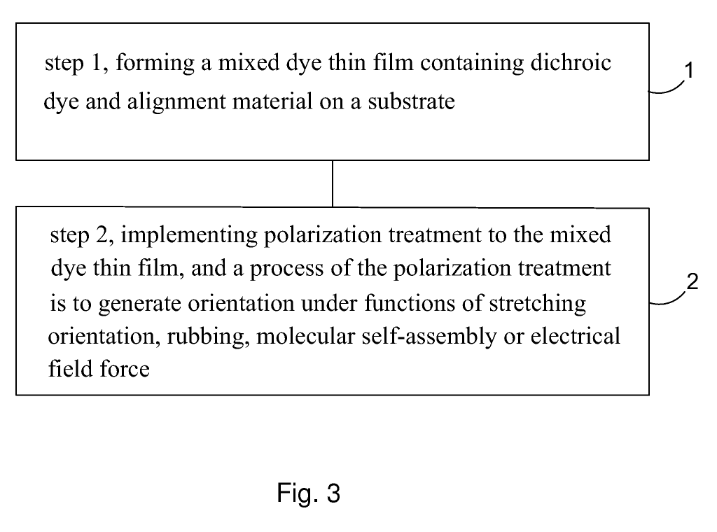

Please refer to FIG. 3. The present invention provides a manufacture method of a polarization and alignment function integration film, comprising steps of:

step 1, forming a mixed dye thin film containing dichroic dye and alignment material on a substrate;

step 2, implementing polarization treatment to the mixed dye thin film, and a process of the polarization treatment is to generate orientation under functions of stretching orientation, rubbing, molecular self-assembly or electrical field force.

Specifically, the alignment material is normal alignment material or light alignment material.

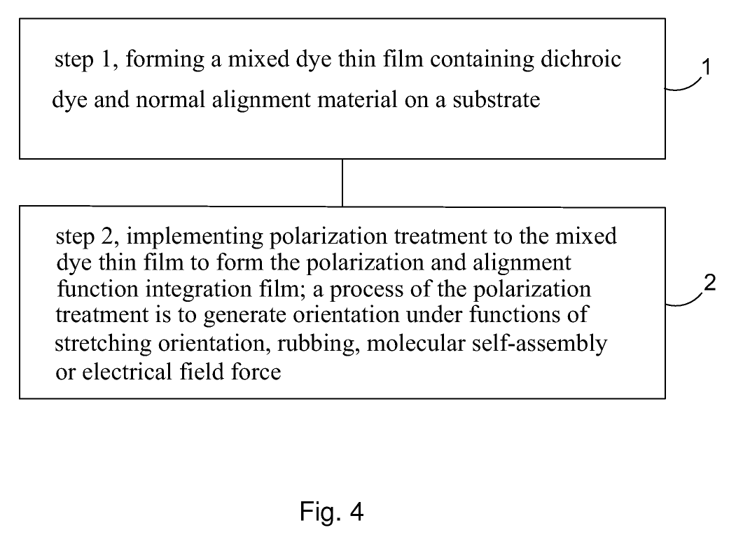

Please refer to FIG. 4, which is a flowchart of the first embodiment of the manufacture method of the polarization and alignment function integration film shown in FIG. 3, and the manufacture method comprises steps of:

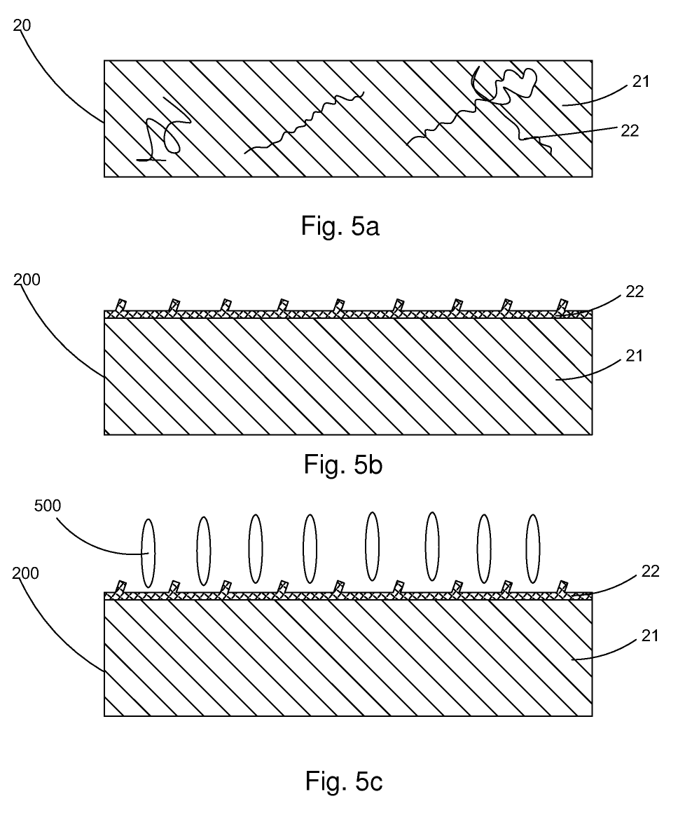

step 1, as shown in FIG. 5a, forming a mixed dye thin film 20 containing dichroic dye 21 and normal alignment material 22 on a substrate.

Specifically, in the step 1, the dichroic dye 21 is azobenzene or anthraquinone, and the normal alignment material 22 is polyimide.

Specifically, in the step 1, a solution film forming method or an evaporation method is employed to form the mixed dye thin film 20.

As in the step 1, the solution film forming method is employed to form the mixed dye thin film 20, the step 1 comprises:

step 11, respectively weighting the dichroic dye 21, the normal alignment material 22 and solvent, and dissolving polarization dye 21 and the normal alignment material 22 in the solvent to manufacture a mixed material;

specifically, the weight of the dichroic dye 21 is larger than the weight of the normal alignment material 22 in the step 11.

Specifically, the solvent can be a combination of one or more of N-methylpyrrolidone (NMP), N-ethyl-pyrrolidone (NEP), Propylene glycol monomethyl ether (PGME), dimethyl ether (DME) or butylcellosolve (BCS).

step 12, providing a substrate, coating the mixed material on the substrate with the solution film forming method, and forming a mixed dye thin film 20 after removing the solvent. Specifically, the solution film forming method is ink jet or spin coating.

As in the step 1, the evaporation method is employed to form the mixed dye thin film 20, the step 1 comprises:

step 11′, respectively weighting the dichroic dye 21 and the normal alignment material 22, and uniformly mixing the two to obtain a mixed material.

Specifically, the weight of the dichroic dye 21 is larger than the weight of the normal alignment material 22 in the step 11′.

step 12′, providing a substrate, and plating the mixed material on the substrate with the evaporation method to form a mixed dye thin film 20.

step 2, as shown in FIG. 5b, implementing polarization treatment to the mixed dye thin film 20 to form the polarization and alignment function integration film 200.

Specifically, in the step 2, a process of the polarization treatment is to generate orientation under functions of stretching orientation, rubbing, molecular self-assembly or electrical field force. After the polarization treatment, the dichroic dye 21 in the mixed dye thin film 20 is aligned according to a certain way to make the polarization and alignment function integration film 200 possess polarization property, and meanwhile, the normal alignment material 22 in the mixed dye thin film 20 is aligned according to another way to make the polarization and alignment function integration film 200 possess alignment function, too.

Specifically, after the polarization treatment in the step 2, if the alignment result of the normal alignment material 22 in the polarization and alignment function integration film 200 is unsatisfactory. Another rubbing alignment treatment can be implemented to the polarization and alignment function integration film 200 to promote the alignment function of the polarization and alignment function integration film 200.

Specifically, as shown in FIG. 5c, the aforesaid polarization and alignment function integration film 200 is applied in the liquid crystal display panel, and the polarization and alignment function integration film 200 can align the liquid crystal molecules 500 in a certain direction.

On the base of the aforesaid manufacture method of the polarization and alignment function integration film, the present invention further provides a polarization and alignment function integration film comprising dichroic dye and normal alignment material.

Specifically, the dichroic dye is azobenzene or anthraquinone, and the normal alignment material is polyimide. Preferably, the content of the dichroic dye is larger than the content of the normal alignment material in the polarization and alignment function integration film.

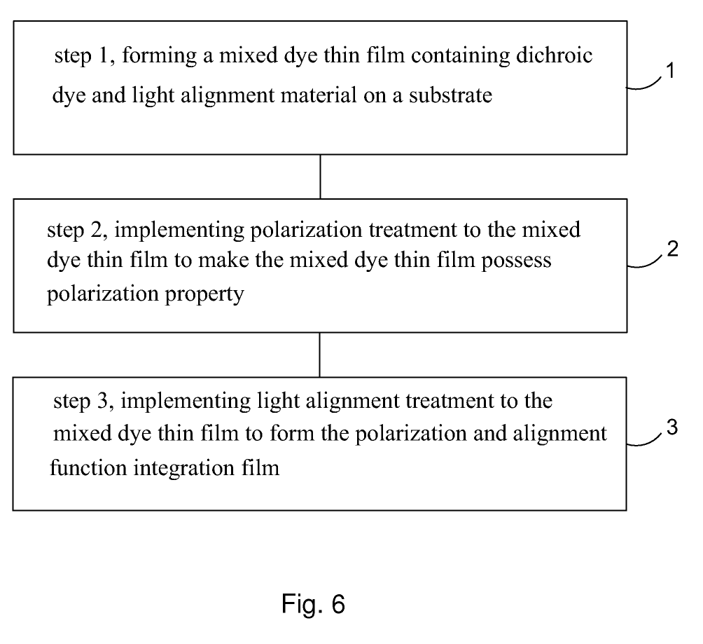

Please refer to FIG. 6, which is a flowchart of the second embodiment of the manufacture method of the polarization and alignment function integration film shown in FIG. 3, and the manufacture method comprises steps of:

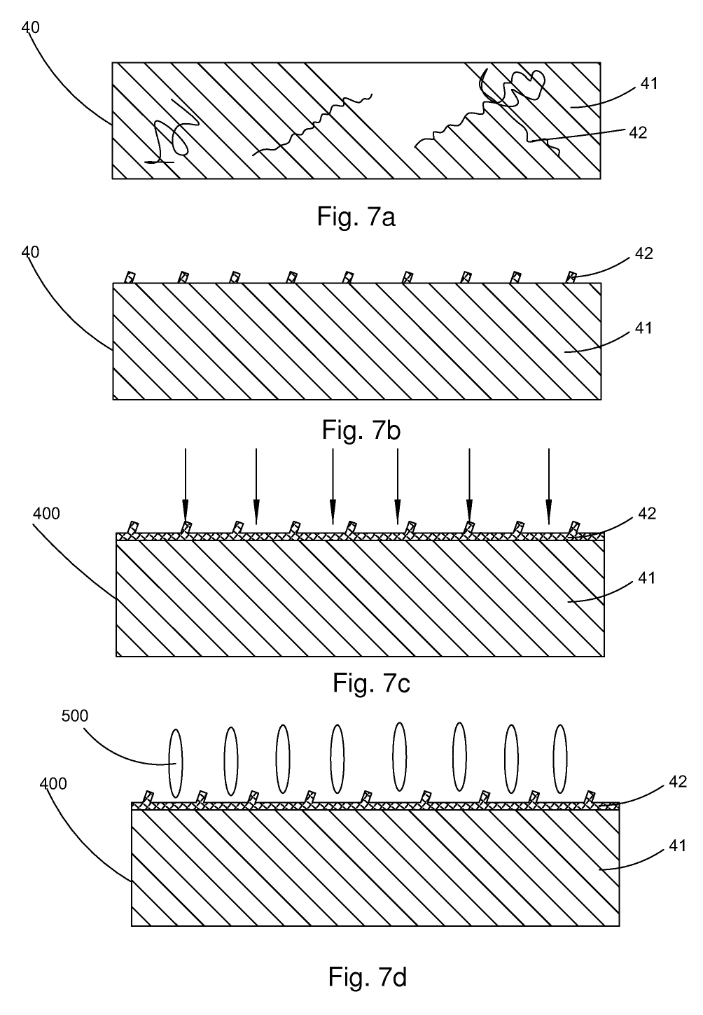

step 1, as shown in FIG. 7a, forming a mixed dye thin film 40 containing dichroic dye 41 and light alignment material 42.

Specifically, in the step 1, the dichroic dye 41 is azobenzene or anthraquinone.

Specifically, in the step 1, a solution film forming method or an evaporation method is employed to form the mixed dye thin film 40.

As in the step 1, the solution film forming method is employed to form the mixed dye thin film 40, the step 1 comprises:

step 11, respectively weighting the dichroic dye 41, the light alignment material 42 and solvent, and dissolving polarization dye 41 and the light alignment material 42 in the solvent to manufacture a mixed material.

Specifically, the weight of the dichroic dye 41 is larger than the weight of the normal alignment material 42 in the step 11.

Specifically, the solvent can be a combination of one or more of N-methylpyrrolidone (NMP), N-ethyl-pyrrolidone (NEP), Propylene glycol monomethyl ether (PGME), dimethyl ether (DME) or butylcellosolve (BCS).

step 12, providing a substrate, coating the mixed material on the substrate with the solution film forming method, and forming a layer of mixed dye thin film 40 after removing the solvent; specifically, the solution film forming method is ink jet or spin coating.

As in the step 1, the evaporation method is employed to form the mixed dye thin film 40, the step 1 comprises:

step 11′, respectively weighting the dichroic dye 41 and the light alignment material 42, and uniformly mixing the two to obtain a mixed material;

Specifically, the weight of the dichroic dye 41 is larger than the weight of the normal alignment material 42 in the step 11′.

step 12′, providing a substrate, and plating the mixed material on the substrate with the evaporation method to form a mixed dye thin film 40.

step 2, as shown in FIG. 7b, implementing polarization treatment to the mixed dye thin film 40 to make the mixed dye thin film 40 possess polarization property.

Specifically, in the step 2, a process of the polarization treatment is to generate orientation under functions of stretching orientation, rubbing, molecular self-assembly or electrical field force. After the polarization treatment, the dichroic dye 41 in the mixed dye thin film 40 is aligned according to a certain way to make the mixed dye thin film 40 possess polarization property.

step 3, as shown in FIG. 7c, implementing light treatment to the mixed dye thin film 40 to form the polarization and alignment function integration film 400.

Specifically, after the light alignment treatment, the normal alignment material 42 in the mixed dye thin film 40 is aligned according to another way to make the polarization and alignment function integration film 400 possess alignment function.

Specifically, as shown in FIG. 7d, the aforesaid polarization and alignment function integration film 400 is applied in the liquid crystal display panel, and the polarization and alignment function integration film 400 can align the liquid crystal molecules 500 in a certain direction.

On the base of the aforesaid manufacture method of the polarization and alignment function integration film, the present invention further provides a polarization and alignment function integration film comprising dichroic dye and light alignment material.

Specifically, the dichroic dye is azobenzene or anthraquinone. Preferably, the content of the dichroic dye is larger than the content of the light alignment material in the polarization and alignment function integration film.

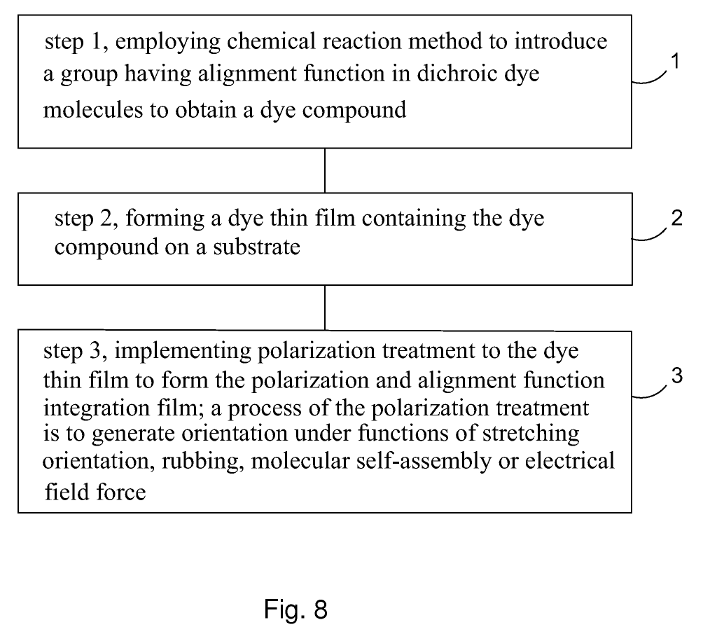

Please refer to FIG. 8. The present invention provides another manufacture method of a polarization and alignment function integration film, comprising steps of:

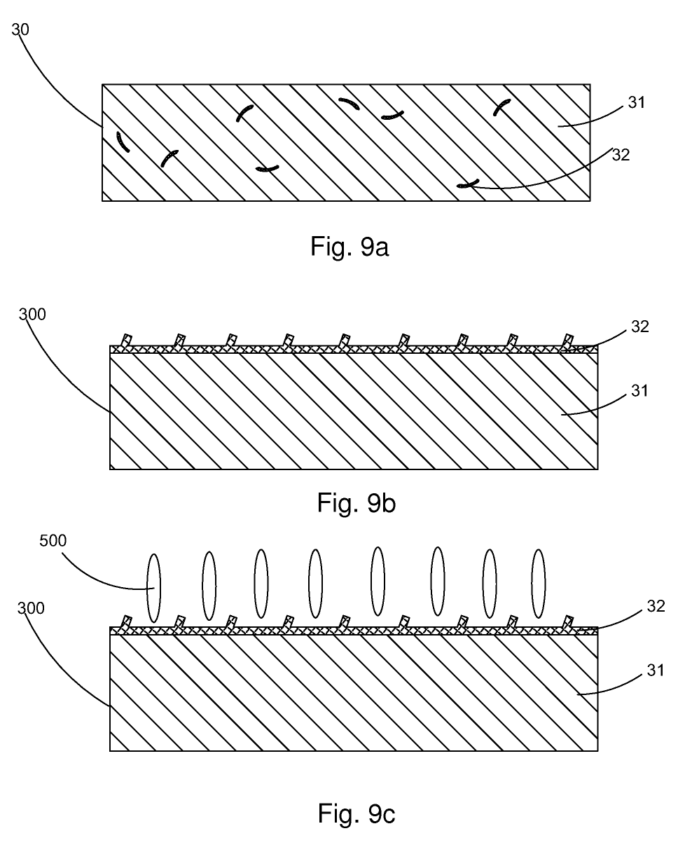

step 1, as shown in FIG. 9a, employing chemical reaction method to introduce a group 32 having alignment function in dichroic dye molecules 31 to obtain a dye compound.

Specifically, in the step 1, the dichroic dye molecules 31 are azobenzene or anthraquinone.

step 2, forming a dye thin film containing the dye compound on a substrate 30.

Specifically, in the step 2, a solution film forming method or an evaporation method is employed to form the dye thin film 30.

As in the step 2, the solution film forming method is employed to form the dye thin film 30, the step 2 comprises:

step 21, respectively weighting the dye compound and solvent, and dissolving dye compound in the solvent to manufacture a mixed material.

Specifically, the solvent can be a combination of one or more of N-methylpyrrolidone (NMP), N-ethyl-pyrrolidone (NEP), Propylene glycol monomethyl ether (PGME), dimethyl ether (DME) or butylcellosolve (BCS).

step 22, providing a substrate, coating the mixed material on the substrate with the solution film forming method, and forming a dye thin film 30 after removing the solvent.

Specifically, the solution film forming method is ink jet or spin coating.

as in the step 2, the evaporation method is employed to form the dye thin film 30, the step 2 is: weighting the dye compound of a proper volume, and providing a substrate, and plating the dye compound on the substrate with the evaporation method to form the dye thin film 30.

step 3, as shown in FIG. 9b, implementing polarization treatment to the dye thin film 30 to form the polarization and alignment function integration film 300.

Specifically, in the step 3, a process of the polarization treatment is stretching orientation, rubbing or molecular self-assembly. After the polarization treatment, the dichroic dye molecules 31 in the polarization and alignment function integration film 300 is aligned according to a certain way to make the polarization and alignment function integration film 300 possess polarization property, and meanwhile, the group 32 having alignment function, which is grafted with the dichroic dye molecules 31, is aligned according to another way to make the polarization and alignment function integration film 300 possess alignment function, too.

Specifically, as shown in FIG. 9c, the aforesaid polarization and alignment function integration film 300 is applied in the liquid crystal display panel, and the polarization and alignment function integration film 300 can align the liquid crystal molecules 500 in a certain direction.

On the base of the aforesaid manufacture method of the polarization and alignment function integration film, the present invention further provides a polarization and alignment function integration film. The material is a dye compound, which is obtained by introducing a group having alignment function in dichroic dye molecules.

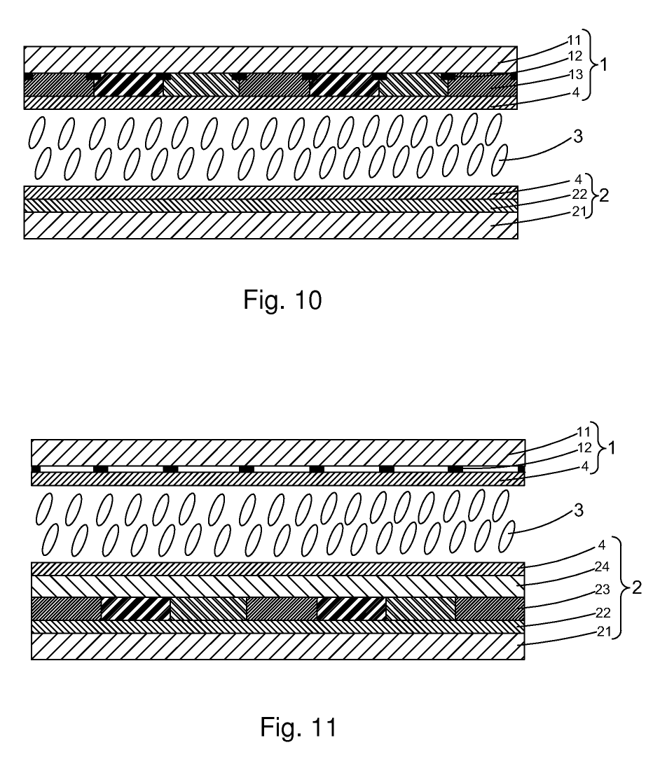

Please refer to FIGS. 10-11. The present invention further provides a liquid crystal display panel, comprising the aforesaid polarization and alignment function integration film, comprising an upper substrate 1 and a lower substrate 2 which are oppositely located and a liquid crystal layer 3 located between the upper substrate 1 and the lower substrate 2, wherein polarization and alignment function integration films 4 are located on surfaces at sides of the upper substrate 1 and the lower substrate 2 facing the liquid crystal layer 3.

The polarization and alignment function integration films 4 can be polarization and alignment function integration films obtained by utilizing any one of the aforesaid manufacture methods. Specifically, material of the polarization and alignment function integration films 4 can be one of the following 3 solutions:
a) comprising dichroic dye and normal alignment material;
b) a dye compound, which is obtained by introducing a group having alignment function in dichroic dye molecules;
c) comprising dichroic dye and light alignment material;

Specifically, the dichroic dye is azobenzene or anthraquinone, and the normal alignment material is polyimide.

The polarization and alignment function integration film 4 has polarization property and alignment function to act alignment function to the liquid crystals, and meanwhile, the light entering the liquid crystals is adjusted to be in a polarization state, i.e. the linearly polarized light. The liquid crystals can act to have function of optical switch under control of the TFT switch to prevent the light leakage.

Specifically, referring to FIG. 10, which is the first embodiment of the liquid crystal display panel according to the present invention. In the first embodiment, the upper substrate 1 comprises a first substrate 11, a black matrix 12 located on the first substrate 11, a color resist layer 13 located on the first substrate 11 and the black matrix 12 and a polarization and alignment function integration films 4 located on the color resist layer 13;

the lower substrate 2 comprises a second substrate 21, a thin film transistor layer 22 located on the second substrate 21, a polarization and alignment function integration films 4 located on the thin film transistor layer 22.

Preferably, both the first substrate 11 and the second substrate 21 are glass substrates.

Besides, the black matrix 12 can be on the lower substrate 2, which is at a position of different side of the color resist layer 13.

Specifically, referring to FIG. 11, which is the second embodiment of the liquid crystal display panel according to the present invention. In the second embodiment, the upper substrate 1 comprises a first substrate 11, a black matrix 12 located on the first substrate 11 and a polarization and alignment function integration films 4 located on the black matrix 12;

the lower substrate 2 comprises a second substrate 21, a thin film transistor layer 22 located on the second substrate 21, a color resist layer 23 located on the thin film transistor layer 22, a pixel electrode layer 24 located on the color resist layer 23 and a polarization and alignment function integration films 4 located on the pixel electrode layer 24.

Preferably, both the first substrate 11 and the second substrate 21 are glass substrates.

Besides, the black matrix 12 can be on the lower substrate 2, which is at a position of the same side of the color resist layer 13.

Material of pixel electrode layer 24 is ITO (Indium Tin Oxide).

There is no restriction to the liquid crystal drive mode in the liquid crystal display panel according to the present invention. Multiple modes, such as IPS (In-Plane Switch), TN (Twisted Nematic), VA (Vertical Alignment).

In conclusion, the present invention provides a manufacture method of a polarization and alignment function integration film and a liquid crystal display panel comprising the polarization and alignment function integration film. The manufactured polarization and alignment function integration film manufactured by the manufactured method has polarization property and alignment function. As the polarization and alignment function integration film is applied in the liquid crystal display panel, it can replace the polarizer and the alignment film in the liquid crystal display panel according to prior art for decreasing the type and the amount of the optical films and saving one polarizer alignment process. Significantly, the production process is simplified and the production cost is saved to gain the benefits of cost reduction. Besides, the polarization and alignment function integration film is particularly applicable for the liquid crystal display panel structure which needs to locate the polarizer inside. The present invention provides a liquid crystal display panel, which uses the polarization and alignment function integration film having polarization property and alignment function to replace the polarizer and the alignment film in the liquid crystal display panel according to prior art for decreasing the type and the amount of the optical films and saving one polarizer alignment process. Significantly, the production process is simplified and the production cost is saved to gain the benefits of cost reduction.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A manufacture method of a polarization and alignment function integration film, comprising steps of:
step 1, forming a mixed dye thin film containing dichroic dye and alignment material on a substrate;
step 2, implementing polarization treatment to the mixed dye thin film, and a process of the polarization treatment is to generate orientation under functions of stretching orientation, rubbing, molecular self-assembly or electrical field force.

2. The manufacture method of the polarization and alignment function integration film according to claim 1, wherein the alignment material is normal alignment material or light alignment material.

3. The manufacture method of the polarization and alignment function integration film according to claim 2, wherein as the alignment material is normal alignment material, after the polarization treatment in the step 2, the dichroic dye in the mixed dye thin film is aligned according to a way, and the normal alignment material in the mixed dye thin film is aligned according to another way to form the polarization and alignment function integration film.

4. The manufacture method of the polarization and alignment function integration film according to claim 2, wherein as the alignment material is light alignment material, the method further comprises step 3, implementing light alignment treatment to the mixed dye thin film to form the polarization and alignment function integration film.

5. The manufacture method of the polarization and alignment function integration film according to claim 1, wherein the dichroic dye is azobenzene or anthraquinone.

6. The manufacture method of the polarization and alignment function integration film according to claim 1, wherein in the step 1, a solution film forming method or an evaporation method is employed to form the mixed dye thin film;
as in the step 1, the solution film forming method is employed to form the mixed dye thin film, the step 1 comprises:
step 11, respectively weighting the dichroic dye, the alignment material and solvent, and dissolving polarization dye and the alignment material in the solvent to manufacture a mixed material;
step 12, providing a substrate, coating the mixed material on the substrate with the solution film forming method, and forming a mixed dye thin film after removing the solvent;
as in the step 1, the evaporation method is employed to form the mixed dye thin film, the step 1 specifically comprises:
step 11′, respectively weighting the dichroic dye and the alignment material, and uniformly mixing the two to obtain a mixed material;
step 12′, providing a substrate, and plating the mixed material on the substrate with the evaporation method to form a mixed dye thin film.

7. A manufacture method of a polarization and alignment function integration film, comprising steps of:
step 1, employing chemical reaction method to introduce a group having alignment function in dichroic dye molecules to obtain a dye compound;
step 2, forming a dye thin film containing the dye compound on a substrate;
step 3, implementing polarization treatment to the mixed dye thin film to form the polarization and alignment function integration film; a process of the polarization treatment is to generate orientation under functions of stretching orientation, rubbing, molecular self-assembly or electrical field force.

8. The manufacture method of the polarization and alignment function integration film according to claim 7, wherein in the step 2, a solution film forming method or an evaporation method is employed to form the dye thin film;
as in the step 2, the solution film forming method is employed to form the dye thin film, the step 2 specifically comprises:
step 21, respectively weighting the dye compound and solvent, and dissolving dye compound in the solvent to manufacture a mixed material;
step 22, providing a substrate, coating the mixed material on the substrate with the solution film forming method, and forming a dye thin film after removing the solvent;
as in the step 2, the evaporation method is employed to form the dye thin film, the step 2 specifically is: weighting the dye compound of a proper volume, and providing a substrate, and plating the dye compound on the substrate with the evaporation method to form a dye thin film.

9. The manufacture method of the polarization and alignment function integration film according to claim 7, wherein the dichroic dye is azobenzene or anthraquinone.

10. A liquid crystal display panel, comprising an upper substrate and a lower substrate which are oppositely located and a liquid crystal layer located between the upper substrate and the lower substrate, wherein polarization and alignment function integration films are located on surfaces at sides of the upper substrate and the lower substrate facing the liquid crystal layer;
wherein the manufacture method of the polarization and alignment function integration film comprises steps of:
step 1, forming a mixed dye thin film containing dichroic dye and alignment material;
step 2, implementing polarization treatment to the mixed dye thin film, and a process of the polarization treatment is to generate orientation under functions of stretching orientation, rubbing, molecular self-assembly or electrical field force.

11. The liquid crystal display panel according to claim 10, wherein the alignment material is normal alignment material or light alignment material.

12. The liquid crystal display panel according to claim 11, wherein as the alignment material is normal alignment material, after the polarization treatment in the step 2, the dichroic dye in the mixed dye thin film is aligned according to a way, and the normal alignment material in the mixed dye thin film is aligned according to another way to form the polarization and alignment function integration film.

13. The liquid crystal display panel according to claim 11, wherein as the alignment material is light alignment material, the method further comprises step 3, implementing light alignment treatment to the mixed dye thin film to form the polarization and alignment function integration film.

14. The liquid crystal display panel according to claim 10, wherein the dichroic dye is azobenzene or anthraquinone.

15. The liquid crystal display panel according to claim 10, wherein in the step 1, a solution film forming method or an evaporation method is employed to form the mixed dye thin film;
as in the step 1, the solution film forming method is employed to form the mixed dye thin film, the step 1 comprises:
step 11, respectively weighting the dichroic dye, the alignment material and solvent, and dissolving polarization dye and the alignment material in the solvent to manufacture a mixed material;
step 12, providing a substrate, coating the mixed material on the substrate with the solution film forming method, and forming a mixed dye thin film after removing the solvent;
as in the step 1, the evaporation method is employed to form the mixed dye thin film, the step 1 specifically comprises:
step 11′, respectively weighting the dichroic dye and the alignment material, and uniformly mixing the two to obtain a mixed material;
step 12′, providing a substrate, and plating the mixed material on the substrate with the evaporation method to form a mixed dye thin film.
